(19) United States
(12) Patent Application Publication
(10) Pub. No.: US 2025/0370605 A1
(43) Pub. Date: Dec. 4, 2025

(54) IMPLEMENTING DRAG-BASED IMAGE EDITING

(71) Applicant: Lemon Inc., Grand Cayman (KY)

(72) Inventors: Jun Hao Liew, Singapore (SG); Yujun Shi, Singapore (SG); Hanshu Yan, Singapore (SG); Jiashi Feng, Singapore (SG)

(21) Appl. No.: 18/792,508

(22) Filed: Aug. 1, 2024

Related U.S. Application Data
(60) Provisional application No. 63/653,685, filed on May 30, 2024.

(51) Int. Cl. G06F 3/04845; G06V 10/764; G06V 10/77

(52) U.S. Cl. CPC G06F 3/04845; G06V 10/764; G06V 10/7715

(57) ABSTRACT

The present disclosure describes techniques for implementing drag-based image editing. Feature maps are generated based on latent representations of an image by a first sub-model of a machine learning model. The first sub-model is configured to preserve an identity of the image. Embeddings corresponding to at least one pair of points are generated by a second sub-model of the machine learning model. Each pair of points comprises a handle point and a target point. The handle point identifies an area of the image. The target point indicates a target location to which the area is to be relocated. The feature maps and the embeddings are injected into a third sub-model of the machine learning model to guide a process of generating a target image by the third sub-model. The target image depicts the area of the image relocated at the target location.

### CROSS-REFENCE TO RELATED APPLICATION

The present disclosure claims priority to the U.S. Provisional Application No. 63/653,685, filed on May 30, 2024, which is incorporated herein by reference in its entirety.

### BACKGROUND

Machine learning models are increasingly being used across a variety of industries to perform a variety of different tasks. Such tasks may include image editing tasks. Improved techniques for image editing tasks are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing drag-based image editing in accordance with the present disclosure.

FIG. 2 shows an example system for implementing drag-based image editing in accordance with the present disclosure.

FIG. 3 shows example effects of different classifier-free guidance scale schedules in accordance with the present disclosure.

FIG. 4 shows example training data in accordance with the present disclosure.

FIG. 5 shows example point augmentation in accordance with the present disclosure.

FIG. 6 shows example sequential dragging in accordance with the present disclosure.

FIG. 7 shows an example process for implementing drag-based image editing in accordance with the present disclosure.

FIG. 8 shows an example process for implementing drag-based image editing in accordance with the present disclosure.

FIG. 9 shows an example process for implementing drag-based image editing in accordance with the present disclosure.

FIG. 10 shows an example process for implementing drag-based image editing in accordance with the present disclosure.

FIG. 11 shows an example process for implementing drag-based image editing in accordance with the present disclosure.

FIG. 12 shows an example process for implementing drag-based image editing in accordance with the present disclosure.

FIG. 13 shows an example process for generating training pairs and training a machine learning model on the training pares in accordance with the present disclosure.

FIG. 14 shows an example process for implementing drag-based image editing in accordance with the present disclosure.

FIG. 15 shows a table illustrating example evaluation results in accordance with the present disclosure.

FIG. 16 shows a table illustrating example evaluation results in accordance with the present disclosure.

FIG. 17 shows an example computing device which may be used to perform any of the techniques disclosed herein.

### DETAILED DESCRIPTION OF ILLUSTRATIVE EMBODIMENTS

Image editing using generative models is becoming increasingly popular. However, existing approaches for image editing using generative models lack the ability to conduct fine-grained spatial control and/or have drawbacks. A common drawback among existing approaches for image editing using generative models is their lack of efficiency. Prior to editing a real image input by the user, some existing techniques require applying a lengthy pivotal-tuning-inversion, a process that can consume up to two minutes. Existing diffusion-based approaches typically involve time-consuming operations, such as latent-optimization or gradient-based guidance, during editing. This inefficiency poses a significant barrier to practical deployment in real world scenarios. Further undermining the user experiences is the low success rate of these existing techniques. As the existing techniques are mostly zero-shot methods that lack explicit supervision to perform drag-based editing, they frequently struggle with accurately moving semantic content and/or preserving the appearance and identity of the source image. As such, improved techniques for implementing drag-based image editing are needed.

Described here are improved techniques for implementing drag-based image editing. The techniques described herein achieve state-of-the-art drag-based editing performance while drastically reducing latency, thereby making drag-based editing highly practical for deployment. To attain such rapid drag-based editing, the drag-based editing task is redefined as a specific form of conditional generation, where the source image and the drag instructions serve as conditions. A reference-only architecture is leveraged to process source images for identity preservation.

Additionally, to incorporate the drag instruction into the generation process, the handle and target points are encoded into corresponding embeddings. These embeddings can be injected into self-attention modules of a backbone diffusion model to guide the generation process. This approach eliminates the need for repeatedly computing gradients on diffusion latents during inference, as is required by many existing techniques, thereby significantly reducing latency to that of generating an image with diffusion models. As a conditional generation pipeline, the techniques described herein can be further accelerated by integrating off-the-shelf acceleration modules for diffusion models, a capability that is not possible with previous gradient-based methods.

To train the machine learning model described herein, video frames can be leveraged as supervision signals. Video motions inherently encapsulate transformations relevant to drag-based editing, such as object translations, changing poses and orientations, zooming in and out, etc. Training data can be constructed from paired video frames. First, pixels that exhibit significant optical flow magnitude on the first frame as the handle points can be sampled. Next, the handle points' corresponding target points in the second frame can be identified. This procedure allows for the construction of training pairs on a large scale. By learning from such large-scale video frames, this approach significantly outperforms previous methods in terms of both accuracy and consistency.

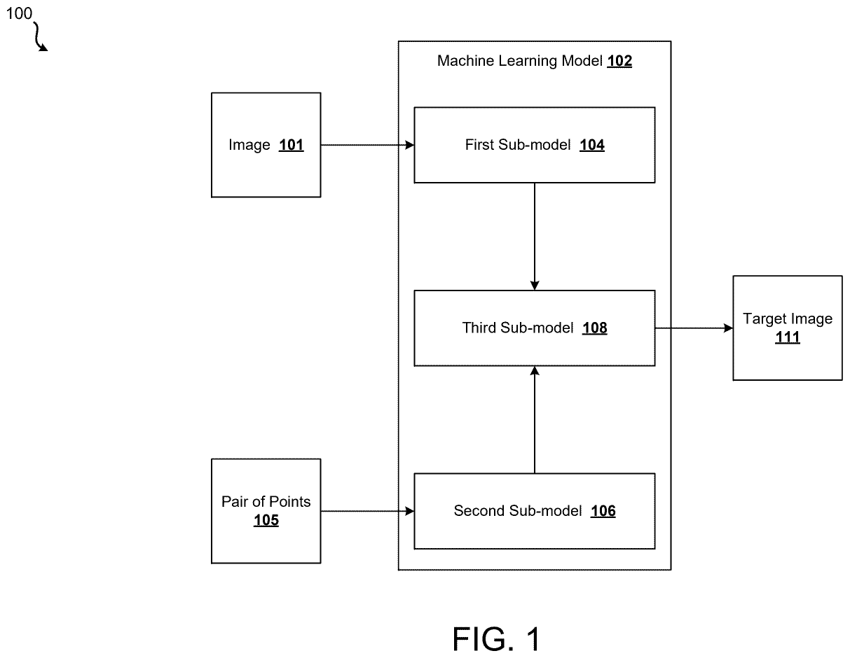

Described herein are improved techniques for implementing drag-based image editing. FIG. 1 shows an example system 100 for implementing drag-based image editing in accordance with the present disclosure. The system 100 includes a machine learning model 102. The machine learning model 102 can include a first sub-model 104, a second sub-model 106, and a third sub-model 108.

The first sub-model 104 can generate feature maps associated with an image 101. The first sub-model 104 can generate the feature maps based on latent representations of the image 101. The first sub-model 104 can be configured to preserve an identify of the image 101. The identity of the image 101 can include information of identifying objects in the image, such as information indicating the appearance of the objects in the image. Clean latent representations of the image 101 can be input into the first sub-model 104. The first sub-model 104 can extract the feature maps based on the clean latent representations. The first sub-model 104 can extract the feature maps once, and only once, during the process of generating the target image.

The second sub-model 106 can generate embeddings corresponding to at least one pair of points 105. The pair of points 105 can include a user-specified handle point. The handle point can identify a user-specified area (e.g., region, one or more pixels) of the image 101. The pair of points 105 can include a user-specified target point corresponding to the handle point. The target point can indicate a user-specified target location, such as user-specified target coordinates in the image 101, to which the area is to be relocated or dragged. The handle point can be converted into a handle map. The target point can be converted into a target map. The handle map and the target map can be encoded into the embeddings by the second sub-model 106.

The feature maps and the embeddings can be injected (e.g., input) into the third-sub-model 108 to guide a process of generating a target image 111 by the third sub-model 108. The target image 111 depicts the area of the image 101 relocated to the target location. The third sub-model 108 can be configured to generate the target image 111 based on noised latent representations of the image 101, and masked latent representations of the image 101 and a binary mask that indicate a region of the image 101 to remain unedited during the process of generating the target image 111. The feature maps generated by the first sub-model 104 and the embeddings generated by the second sub-model 106 can be utilized to guide the third sub-model 108 during the process of generating the target image 111 based on the noised latent representations of the image 101, the masked latent representations of the image 101, and the binary mask.

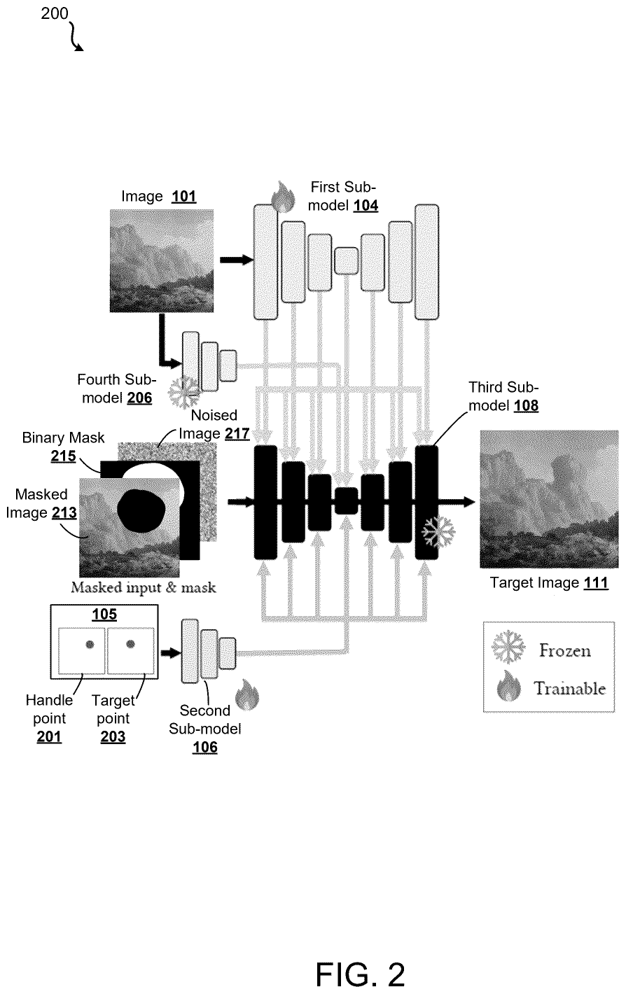

FIG. 2 shows an example system 200 for implementing drag-based image editing in accordance with the present disclosure. The system 200 includes the first sub-model 104 for preserving the identity (e.g., human face, texture, etc.) of the image 101, the second sub-model 106 to encode the handle-target point pairs, the third sub-model 108 to enforce unmasked regions remain untouched and generate a target image.

The third sub-model 108 can include a stable diffusion network (e.g., Stable Diffusion Inpainting U-Net). The third sub-model 108 can receive, as input, a concatenation of the following: noised latent representations 217 of the image 101 (the noised latent representations 217 can be denoted as zₜ), a binary mask 215 (the binary mask 215 can be denoted as M), and masked latent representations 213 (the masked latent representations 213 can be denoted as M⊙z₀^{src}). The third sub-model 108 can generate the target image 111 based on the concatenation. While in-painting backbones typically take in a text prompt to indicate the in-painted content, in a drag-based editing application, a text prompt is not only redundant as the image content is already provided by the image 101, but also difficult for users to provide. Instead, the image feature of the image 101 can be extracted using a fourth sub-model 206 and an empty text prompt can be used, freeing the users from this requirement. The fourth sub-model 206 can include, for example, an image encoder to extract image features from the image 101, and adapted modules with decoupled cross-attention to embed the image features into the third sub-model 108.

As described above, the first sub-model 104 can generate feature maps associated with an image 101. To maintain the identity of the reference image, a reference-only architecture is employed to process the image 101 and generate the feature maps. Unlike a Contrastive Language-Image Pre-Training (CLIP) image encoder, which can only guarantee the overall colors and semantics, the reference-only approach employed by the first sub-model 104 can preserve fine-grained details of the image 101. Inherited from the weights of a pre-trained text-to-image UNet diffusion model, the first sub-model 104 can receive clean latent representations of the image 101 as input. The clean latent representations of the image 101 can be denoted as z₀^{src}. The first sub-model 104 can extract the feature maps from the self-attention layers of the first sub-model 104. By using clean latent representations as inputs to the first sub-model 104, as opposed to noised latent representations used in reference-only models, the first sub-model 104 only needs to extract features from the image 101 once throughout the entire editing process, which improves the model inference efficiency.

The extracted feature maps can be injected into the third sub-model 108. The extracted feature maps can be injected into the third sub-model 108 to guide the self-attention process in the third sub-model 108. The self-attention in the third sub-model 108, guided by the extracted feature maps, can be defined as follows:

$$Attn ( Q , K , V , {K}_{ref} , {V}_{ref} ) = Softmax ( \frac{{Q [ K , {K}_{ref} ]}^{T}}{\sqrt{d}} ) [ V , {V}_{ref} ] \qquad Equation 1$$

where K_{ref} and V_{ref} denote the keys and values extracted from the reference features, and [·, ·] denotes the concatenation operator.

As described above, the second sub-model 106 can generate embeddings corresponding to at least one pair of points 105. The at least one pair of points can include a user-specified handle point 201 and a user-specified target point 203. The handle point 201 and the target point 203in each pair of points 105 are converted into a handle map and a target point map, respectively. The handle map and the target point map can be of the same resolution of the image 101. To convert the user-specified handle point 201 and the user-specified target point 203 in each pair of points 105 into the handle map and the target point map, each pair of handle and target points can be randomly assigned an integer number k∈{1, 2, . . . , N}, where N denotes the maximum number of allowed points. The integer k can be put to the pixel location on the point map, given coordinates specified by the handle and target points. The rest of the pixel locations on the handle and target point maps can be assigned a value of zero.

The handle and target point maps can be encoded into the embedding via the second sub-model 106. The second sub-model 106 can include a point embedding network. The point embedding network can include twelve layers of convolution and Sigmoid Linear Unit (SiLU) activation. The point embedding network can output the embeddings at four different resolutions. The four different resolutions can correspond to the four different resolutions of Stripped-Down UNet (SD UNet) activation maps. To enable the third sub-model 108 to follow point instructions effectively, a point-following mechanism can be introduced into the self-attention in the third sub-model 108, resulting in the following self-attention formulation:

$$Attn ( Q , K , V , {K}_{ref} , {V}_{ref} , {E}_{hdl} , {E}_{tgt} ) = Softmax ( \frac{{( Q + {E}_{tgt} ) [ K + {E}_{tgt} , {K}_{ref} + {E}_{hdl} ]}^{T}}{\sqrt{d}} ) [ V , {V}_{ref} ] \qquad Equation 2$$

where E_{hdl} and E_{tgt} are embeddings of handle an target point maps, respectively. In this way, the similarity between the target points of the generated images and the handle points of the user input image can be explicitly strengthened, facilitating learning of drag-based editing.

Directly using randomly initialized noise latent representations as the input to the third sub-model 108 for generation of the target image can yield unstable results. This instability may stem from the discrepancy between the initial noise during training and testing of diffusion models. In contrast to text-to-image generation, where obtaining a suitable initial noise prior is challenging, a more accurate initialization of the noise prior can be achieved by directly adding noise to the latent representations of the source image (e.g., the image 101). The latent representations of the source image can be represented by the following equation:

$${z}_{t} = \sqrt{{\overline{α}}_{t}} {z}_{0} + \sqrt{1 - {\overline{α}}_{t}} ϵ , \qquad Equation 3$$

where z₀ corresponds to the VAE latent representations of image samples given by users, zₜ is the latent after t steps of the diffusion process, ϵ˜N(0, I), and α̅ₜ is the cumulative product of the noise coefficient αₜ at each step. The noise can be directly added to the latent representations of the source image to the terminal diffusion time-step of t=999.

To further improve the capability of the machine learning model 102 to follow the point instruction during inference, point-following classifier-free guidance (PF-CFG) can be implemented to strengthen the effects of given point (e.g., handle, target) pairs:

$${\tilde{ϵ}}_{θ} ( {z}_{t} , {c}_{appr} , {c}_{points} ) = {ϵ}_{θ} ( {z}_{t} , {c}_{appr} , ∅ ) + ω ( t ) ( {ϵ}_{θ} ( {z}_{t} , {c}_{appr} , {c}_{points} ) - ( {z}_{t} , {c}_{appr} , ∅ ) )$$

where ω(t) is the time dependent CFG scale, cₐₚₚᵣ denotes the source image condition encoded by the first sub-model 104, and cₚₒᵢₙₜₛ denotes the condition of handle and target points. To be more specific, when computing ϵ_{θ}(zₜ, cₐₚₚᵣ, Ø), Equation 1 is used in all self-attention layers of the third sub-model 108. When computing ϵ_{θ}(zₜ, cₐₚₚᵣ, cₚₒᵢₙₜₛ), Equation 2 is employed.

While the third sub-model 108 can apply a fixed CFG scale across different denoising time-steps, a time-dependent CFG scale can instead be used during denoising. A dynamic time-dependent CFG scale can help strike an appropriate balance between the accuracy of point-following and image quality of the results. Denoting max as the maximum value of CFG, we explore the following CFG scale schedules:

$$1 ) No CFG : ω ( t ) = 12 ) Constant : ω ( t ) = {ω}_{max} 3 ) Square : ω ( t ) = {ω}_{max} \times ( 1 - {( 1 - t / 1000 )}^{2} ) + {( 1 - t / 1000 )}^{2} . 4 ) Linear : ω ( t ) = {ω}_{max} \times t / 1000 + ( 1 - t / 1000 ) . 5 ) Inverse square : ω ( t ) = ( {ω}_{{max}^{-}} 1 ) \times {( t / 1000 )}^{2} + 1 .$$

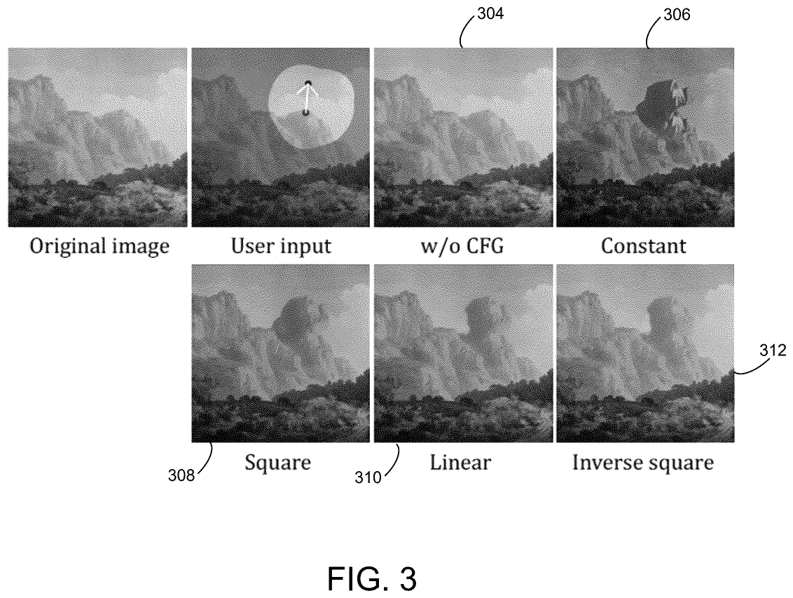

A comparison of these CFG scale schedules in shown in FIG. 3. As shown by the generated image 304, without using CFG, the machine learning model 102 struggles to conduct successful drag-based editing. On the other hand, as shown by the generated image 306, using CFG with a constant scale can successfully drag the handle point to the target point, but the result may suffer from over-saturation. As shown by the generated images 308, 310, and 312, respectively, using square, linear, and inverse square schedules that decay the CFG scale from ωₘₐₓ to 1.0 during the denoising process enables the machine learning model 102 to achieve accurate drag-based editing while markedly improve the image quality. Among these decaying schedules, a fast decaying strategy, such as inverse square, can achieve the best image quality, while a slow decaying strategy, such as linear and square, may still suffer from slight quality degradation (e.g., over-saturation) on generated images.

In embodiments, the machine learning model 102 can be trained on training data that is generated using videos. It can be difficult to collect large-scale paired data for training the machine learning model 102, as obtaining user-annotated input-output pairs on a large scale is nearly infeasible. As such, to generate training data for training the machine learning model 102, the inherent motion captured within videos can be leveraged. The inherent motion captured within videos naturally encompasses various transformations relevant to drag-based editing, including zooming in and out, changes in pose and orientation, etc. These dynamics offer valuable cues for the machine learning model 102 to learn how objects undergo changes and deform.

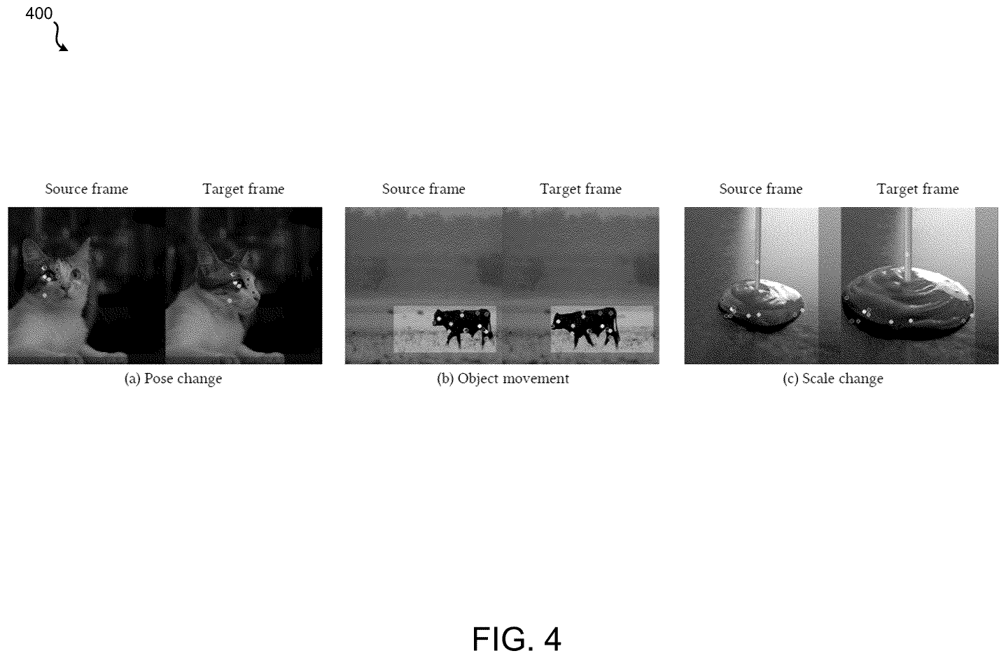

To generate the training data, videos with static camera movement (e.g., movement that simulates drag-based editing where only local regions are manipulated while others remain static) can be curated. Subsequently, two frames can be randomly sampled from a video to serve as source I_{src} and target images I_{tgt}, respectively. Another pair can be resampled if it is determined that the optical flow (e.g., the amount of movement) between the two images is too small. Next, N handle points P_{hdl} can be sampled on I_{src} with a probability proportional to the optical flow strength, ensuring the selection of points with significant movement. A point tracking algorithm can be employed to extract the corresponding target points P_{tgt} in the target image I_{tgt}. Finally, a binary mask M can be extracted. The binary mask M can highlight the motion areas, thereby indicating regions to be edited. Collectively, the tuple (I_{src}, I_{tgt}, P_{hdl}, P_{tgt}, M) form our training samples to train the machine learning model 102. Example training pairs 400 showcasing the versatility of video data for training drag-based editing can be found in FIG. 4.

Some images generated by the machine learning model 102, such as the target image 111, can be of a quality that is unsatisfactory to a user. Such failure cases can be mitigated by engineering the input drag instruction. The user-input drag instruction can be engineered using a point augmentation strategy and/or a sequential dragging strategy. When the region specified by handle points fails to move to the target locations, augmenting the drag instruction with additional pairs of handle and target points has proven effective in improving results. By incorporating more pairs of handle and target points, user editing intentions can be more explicitly conveyed, resulting in better outcomes.

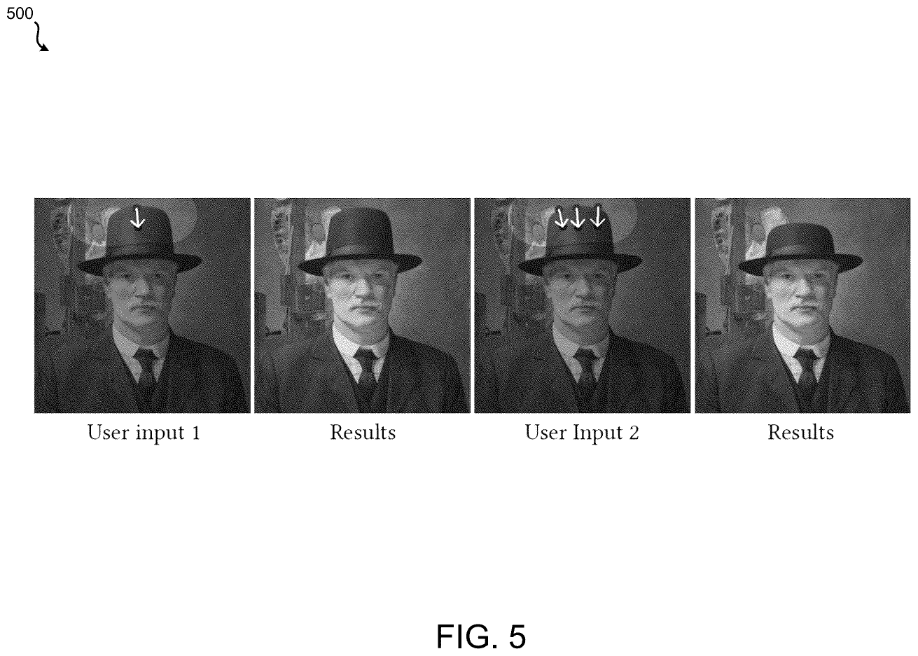

To engineer the drag instruction using the point augmentation strategy, a recommendation (e.g., message, notification) can be presented (e.g., output, displayed) to the user, such as via an interface of a user device. The recommendation can include a recommendation to increase a quantity of pairs of handle and target points. The recommendation can be presented in in response to determining that an editing result does not satisfy a threshold. It can be determined that an editing result does not satisfy a threshold based on user input indicating that the user is not satisfied with the generated image. Referring to the example 500 of FIG. 5, user input 1 only included a single pair of handle and target points. The editing result generated by the machine learning model 102 based on the user input 1 may be unsatisfactory to the user. For example, the hat may not be dragged down far enough in the generated image. As such, a recommendation to increase the quantity of pairs of handle and target points can be presented to the user. In response to this recommendation, the user can add additional handle-target pairs. For example, the user input 2 can include two more handle-target pairs, resulting in a total of three handle-target pairs. The editing result generated by the machine learning model 102 based on the user input 2 may be satisfactory to the user, as the hat is dragged farther down than in the image generated based on user input 1.

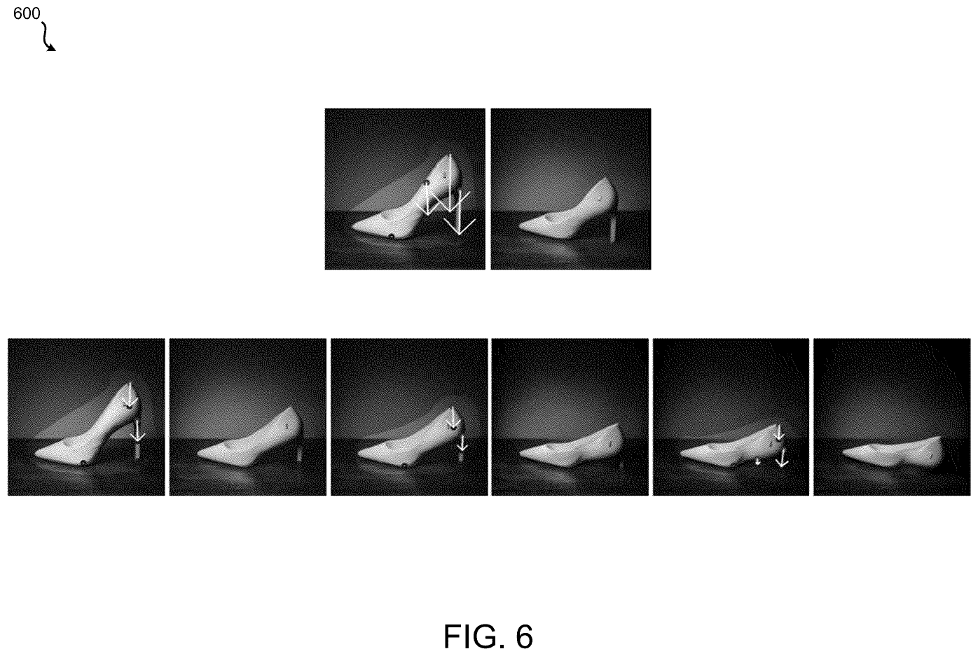

In cases where drag editing results are sub-optimal after one round of editing, users may opt to break down the drag instruction into multiple rounds and sequentially move semantic contents from handle points to final targets. Examples illustrating how such sequential dragging can rectify certain failure cases are presented in FIG. 6. This strategy is facilitated by the exceptional ability of the machine learning model 102 to maintain the appearance and identity of the source image during editing. Without this capability, cumulative appearance shifts might occur, leading to undesired results. Additionally, given the negligible latency of the machine learning model 102, employing sequential dragging does not significantly undermine user experience.

To engineer the drag instruction using the sequential dragging strategy, a recommendation (e.g., message, notification) can be presented (e.g., output, displayed) to the user, such as via an interface of a user device. The recommendation can include a recommendation to employ sequential dragging for editing the image. Referring to the example 600 of FIG. 6, the top row shows sub-optimal drag editing results after one round of editing. For example, the heel of the shoe has not been completely lowered to the ground. As such, a recommendation to use a sequential dragging strategy can be presented to the user. In response to this recommendation, the user can break down the drag instruction into multiple rounds and sequentially move semantic contents from handle points to final targets. The final editing results generated by the machine learning model 102 based on the sequential dragging strategy may be satisfactory to the user, as the heel of the shoe has been completely lowered to the ground.

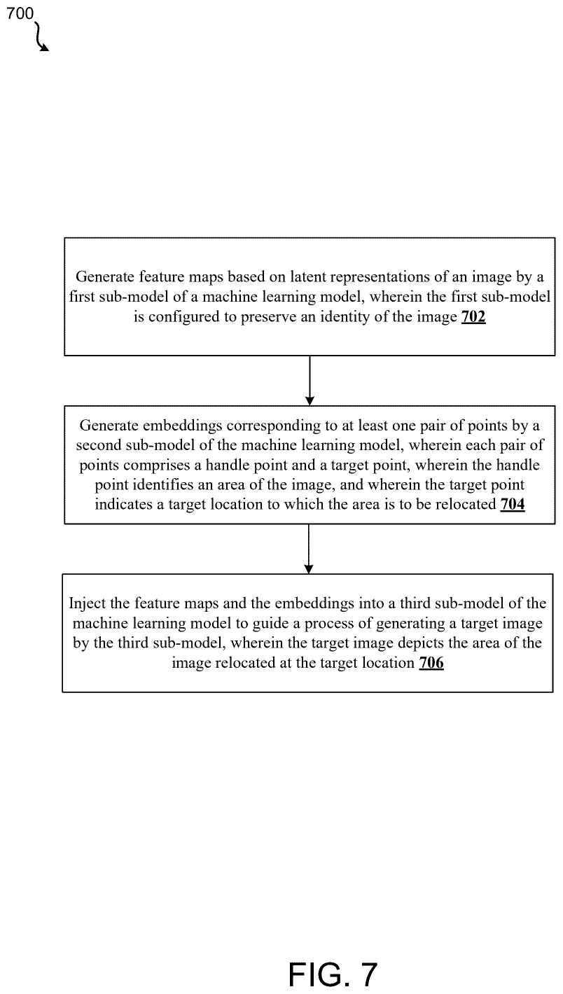

FIG. 7 illustrates an example process 700 for implementing drag-based image editing. Although depicted as a sequence of operations in FIG. 7, those of ordinary skill in the art will appreciate that various embodiments may add, remove, reorder, or modify the depicted operations.

At 702, feature maps can be generated. The feature maps can be generated based on latent representations of an image (e.g., image 101). The feature maps can be generated by a first sub-model (e.g., first sub-model 104) of a machine learning model (e.g., machine learning model 102). The first sub-model can be configured to preserve an identity of the image. The identity of the image can include information of identifying objects in the image, such as information indicating the appearance of the objects in the image.

At 704, embeddings can be generated. The embeddings can correspond to at least one pair of points (e.g., pair of points 105). The embeddings can be generated by a second sub-model (e.g., second sub-model 106) of the machine learning model (e.g., machine learning model 102). Each pair of points (e.g., pair of points 105) comprises a handle point and a target point. The handle point identifies an area (e.g., region, one or more pixels) of the image. The corresponding target point indicates a target location to which the area is to be relocated or dragged.

At 706, the feature maps and the embeddings can be injected into a third sub-model (e.g., third sub-model 108) of the machine learning model. The feature maps and the embeddings can be injected into the third sub-model of the machine learning model to guide a process of generating a target image by the third sub-model. For example, the feature maps and the embeddings can be used to guide the third sub-model during the process of generating the target image based on noised latent representations of the image, masked latent representations of the image, and a binary mask. The target image can depict the area of the image relocated at the target location.

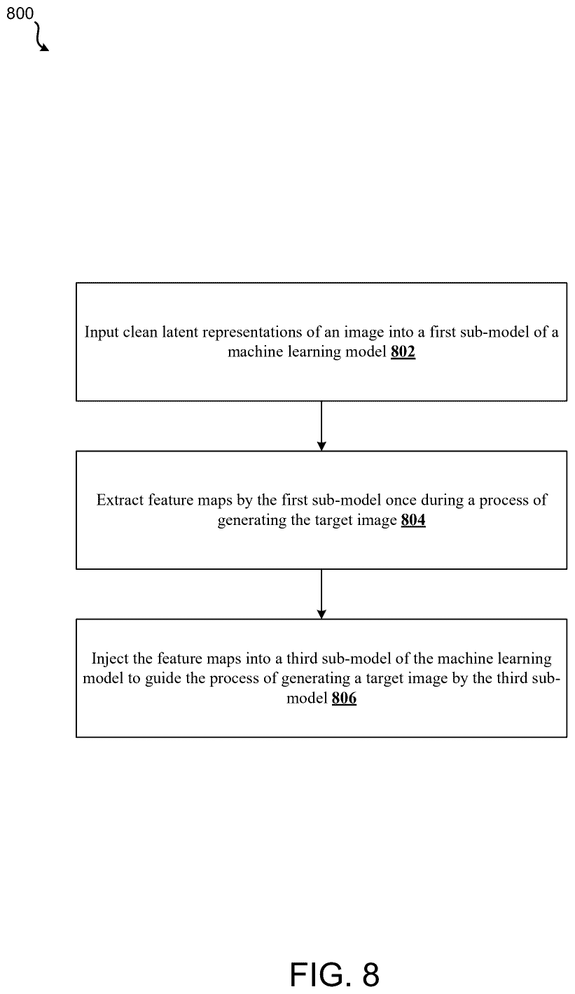

FIG. 8 illustrates an example process 800 for implementing drag-based image editing. Although depicted as a sequence of operations in FIG. 8, those of ordinary skill in the art will appreciate that various embodiments may add, remove, reorder, or modify the depicted operations.

A first sub-model (e.g., the first sub-model 104) of a machine learning model (e.g., machine learning model 102) can generate feature maps associated with an image (e.g., image 101). The first sub-model can generate the feature maps based on latent representations of the image. At 802, clean latent representations of the image can be input into the first sub-model. At 804, feature maps can be extracted by the first sub-model. The feature maps can be extracted by the first sub-model from the self-attention layers of the first sub-model.

By using clean latent representations as inputs to the first sub-model, as opposed to noised latent representations used in reference-only models, the first sub-model only needs to extract the features once throughout the entire editing process, which improves the model inference efficiency. At 806, the feature maps can be injected into a third sub-model (e.g., third sub-model 108) of the machine learning model. The feature maps can be injected into the third sub-model of the machine learning model to guide a process of generating a target image by the third sub-model. For example, the feature maps can be used to guide the third sub-model during the process of generating the target image based on noised latent representations of the image, masked latent representations of the image, and a binary mask. The target image can depict the area of the image relocated at the target location.

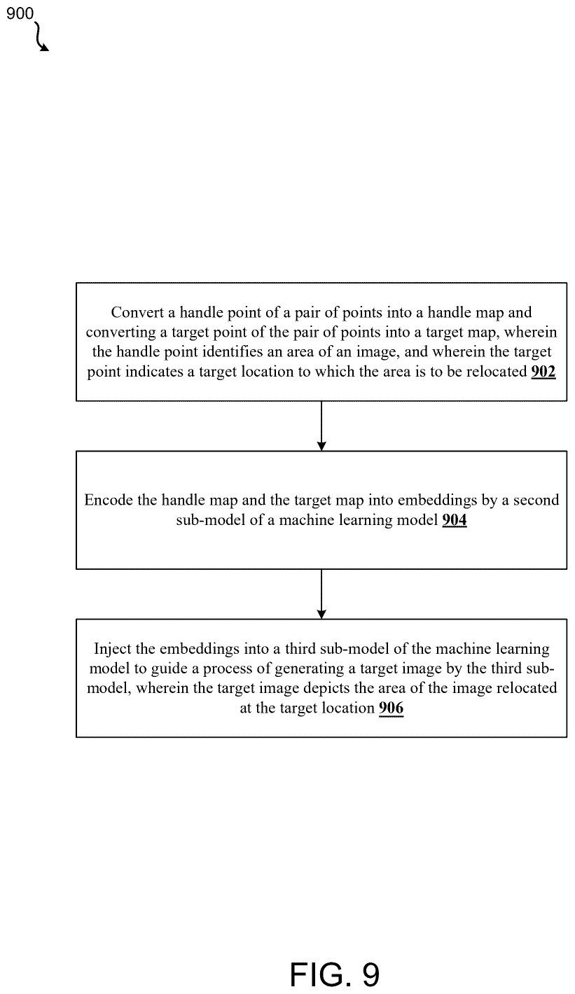

FIG. 9 illustrates an example process 900 for implementing drag-based image editing. Although depicted as a sequence of operations in FIG. 9, those of ordinary skill in the art will appreciate that various embodiments may add, remove, reorder, or modify the depicted operations.

A second sub-model (e.g., second sub-model 106) of a machine learning model (e.g., machine learning model 102) can generate embeddings corresponding to at least one pair of points (e.g., pair of points 105). At 902, a handle point of a pair of points can be converted into a handle map. The handle point can identify a user-specified area (e.g., region, one or more pixels) of an image (e.g., image 101). A corresponding target point of the pair of points can be converted into a target map. The target point can indicate a user-specified target location, such as user-specified target coordinates in the image, to which the area is to be relocated or dragged. At 904, the handle map and the target map can be encoded into the embeddings. The handle map and the target map can be encoded into the embeddings by the second sub-model.

At 906, the embeddings can be injected into a third sub-model (e.g., third sub-model 108) of the machine learning model. The embeddings can be injected into the third sub-model of the machine learning model to guide a process of generating a target image by the third sub-model. For example, the embeddings can be used to guide the third sub-model during the process of generating the target image based on noised latent representations of the image, masked latent representations of the image, and a binary mask. The target image can depict the area of the image relocated at the target location.

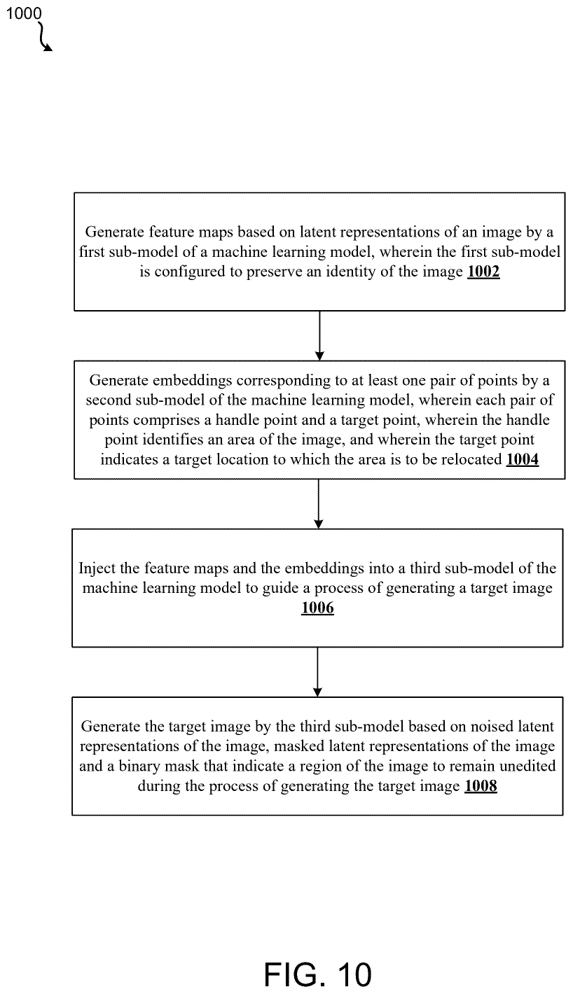

FIG. 10 illustrates an example process 1000 for implementing drag-based image editing. Although depicted as a sequence of operations in FIG. 10, those of ordinary skill in the art will appreciate that various embodiments may add, remove, reorder, or modify the depicted operations.

At 1002, feature maps can be generated. The feature maps can be generated based on latent representations of an image (e.g., image 101). The feature maps can be generated by a first sub-model (e.g., first sub-model 104) of a machine learning model (e.g., machine learning model 102). The first sub-model can be configured to preserve an identity of the image. The identity of the image can include information of identifying objects in the image, such as information indicating the appearance of the objects in the image.

At 1004, embeddings can be generated. The embeddings can correspond to at least one pair of points (e.g., pair of points 105). The embeddings can be generated by a second sub-model (e.g., second sub-model 106) of the machine learning model (e.g., machine learning model 102). Each pair of points (e.g., pair of points 105) comprises a handle point and a target point. The handle point identifies an area (e.g., region, one or more pixels) of the image. The corresponding target point indicates a target location to which the area is to be relocated or dragged.

At 1006, the feature maps and the embeddings can be injected into a third sub-model (e.g., third sub-model 108) of the machine learning model. The feature maps and the embeddings can be injected into the third sub-model of the machine learning model to guide a process of generating a target image by the third sub-model. At 1008, the target image can be generated. The target image can be generated by the third sub-model. The target image can be generated based on noised latent representations of the image, a masked latent representations of the image, and a binary mask. The masked latent representations of the image and the binary mask can both indicate a region of the image to remain unedited during the process of generating the target image. The target image can depict the area of the image relocated at the target location. The feature maps and the embeddings can be used to guide the process of generating the target image based on noised latent representations of the image, masked latent representations of the image, and a binary mask

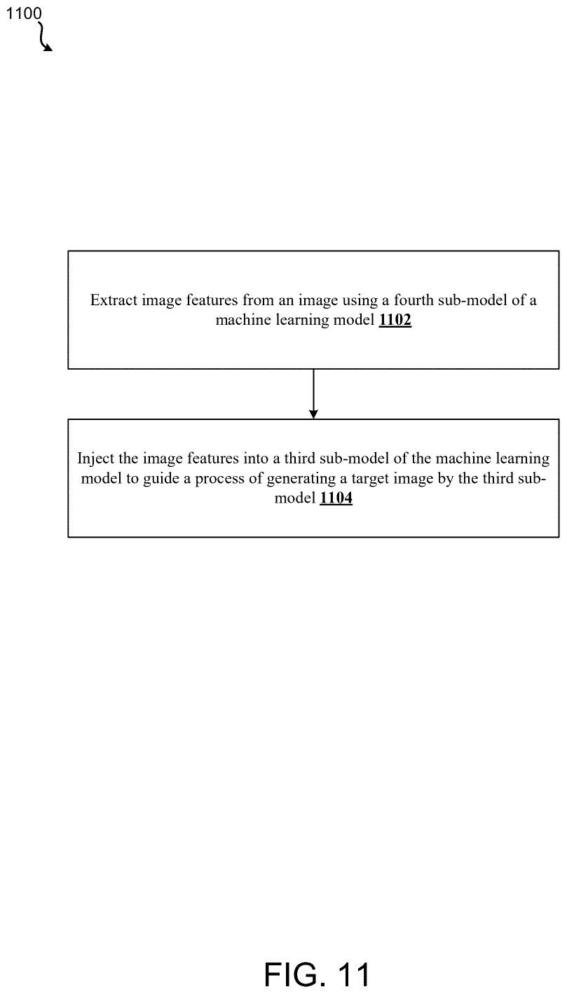

FIG. 11 illustrates an example process 1100 for implementing drag-based image editing. Although depicted as a sequence of operations in FIG. 11, those of ordinary skill in the art will appreciate that various embodiments may add, remove, reorder, or modify the depicted operations.

While in-painting backbones typically take in a text prompt to indicate the in-painted content, in a drag-based editing application, a text prompt is not only redundant as the image content is already provided by the input image, but also difficult for users to provide. To prevent users from needing to input a text prompt, image features can be extracted. At 1102, image features can be extracted from an image (e.g., image 101). The image features can be extracted from the image using a fourth sub-model (e.g., fourth sub-model 206) of a machine learning model (e.g., machine learning model 102). The fourth sub-model can include, for example, an image encoder to extract the image features from the image.

The fourth sub-model can include adapted modules with decoupled cross-attention to embed the image features into a third sub-model (e.g., third sub-model 108) of the machine learning model 102. At 1104, the image features can be injected into the third-sub model. The image features can be injected into the third sub-model of the machine learning model to guide a process of generating a target image by the third sub-model. For example, the image features can be used to guide the third sub-model during the process of generating the target image based on noised latent representations of the image, masked latent representations of the image, and a binary mask. The target image can depict the area of the image relocated at the target location.

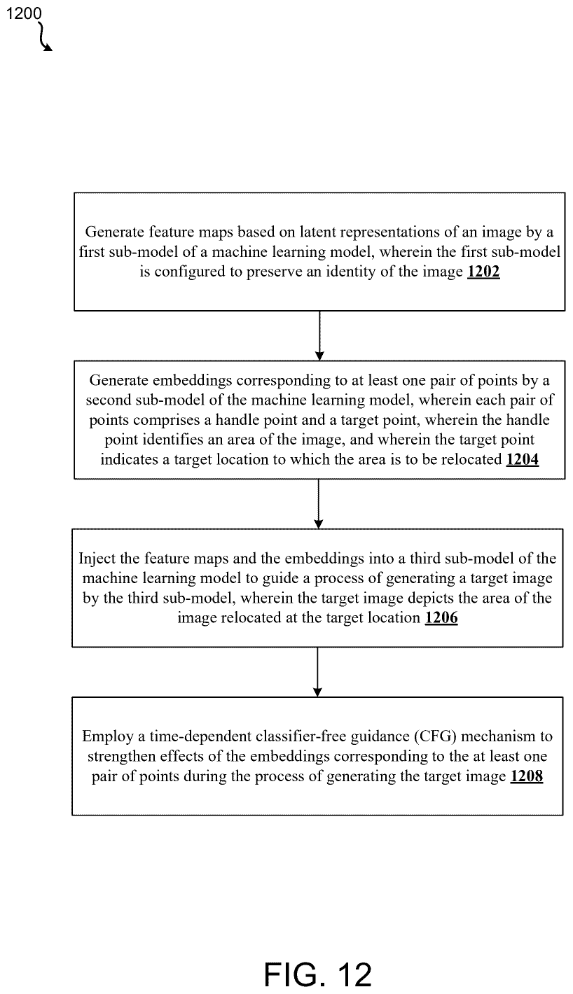

FIG. 12 illustrates an example process 1200 for implementing drag-based image editing. Although depicted as a sequence of operations in FIG. 12, those of ordinary skill in the art will appreciate that various embodiments may add, remove, reorder, or modify the depicted operations.

At 1202, feature maps can be generated. The feature maps can be generated based on latent representations of an image (e.g., image 101). The feature maps can be generated by a first sub-model (e.g., first sub-model 104) of a machine learning model (e.g., machine learning model 102). The first sub-model can be configured to preserve an identity of the image. The identity of the image can include information of identifying objects in the image, such as information indicating the appearance of the objects in the image.

At 1204, embeddings can be generated. The embeddings can correspond to at least one pair of points (e.g., pair of points 105). The embeddings can be generated by a second sub-model (e.g., second sub-model 106) of the machine learning model (e.g., machine learning model 102). Each pair of points (e.g., pair of points 105) comprises a handle point and a target point. The handle point identifies an area (e.g., region, one or more pixels) of the image. The corresponding target point indicates a target location to which the area is to be relocated or dragged.

At 1206, the feature maps and the embeddings can be injected into a third sub-model (e.g., third sub-model 108) of the machine learning model. The feature maps and the embeddings can be injected into the third sub-model of the machine learning model to guide a process of generating a target image by the third sub-model. For example, the feature maps and the embeddings can be used to guide the third sub-model during the process of generating the target image based on noised latent representations of the image, masked latent representations of the image, and a binary mask. The target image can depict the area of the image relocated at the target location.

At 1208, a time-dependent classifier-free guidance (CFG) mechanism can be employed. The time dependent CFG can be employed by the third sub-model during the process of generating the target image. The time dependent CFG can employ a fast decaying strategy, such as inverse square, for example, The time dependent CFG can be employed to strengthen effects of the embeddings corresponding to the at least one pair of points during the process of generating the target image.

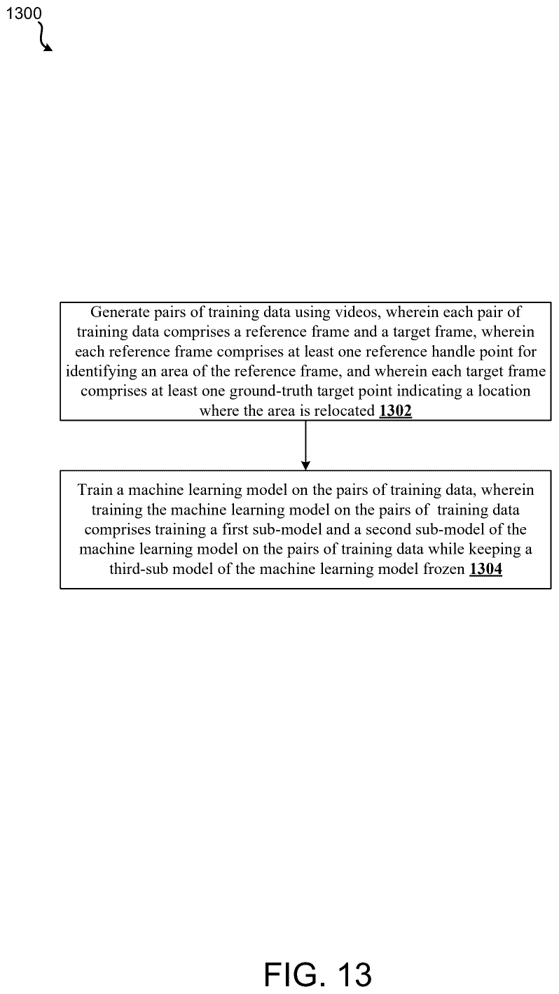

FIG. 13 illustrates an example process 1300 for generating training pairs and training a machine learning model on the training pairs in accordance with the present disclosure. Although depicted as a sequence of operations in FIG. 13, those of ordinary skill in the art will appreciate that various embodiments may add, remove, reorder, or modify the depicted operations.

In embodiments, a machine learning model (e.g., the machine learning model 102) can be trained on training data that is generated using videos. It can be difficult to collect large-scale paired data for training the machine learning model, as obtaining user-annotated input-output pairs on a large scale can be infeasible. As such, to generate training data for training the machine learning model, the inherent motion captured within videos can be leveraged.

At 1302, pairs of training data can be generated using videos. Each pair of training data can include a reference frame and a target frame. Each reference frame comprises at least one reference handle point for identifying an area of the reference frame. Each target frame comprises at least one ground-truth target point indicating a location where the area is relocated. At 1304, the machine learning model can be trained on the pairs of training data. Training the machine learning model on the pairs of training data can include training a first sub-model (e.g., first sub-model 104) of the machine learning model and a second sub-model (e.g., second sub-model 106) of the machine learning model on the pairs of training data while keeping a third-sub model (e.g., third sub-model 108) of the machine learning model frozen.

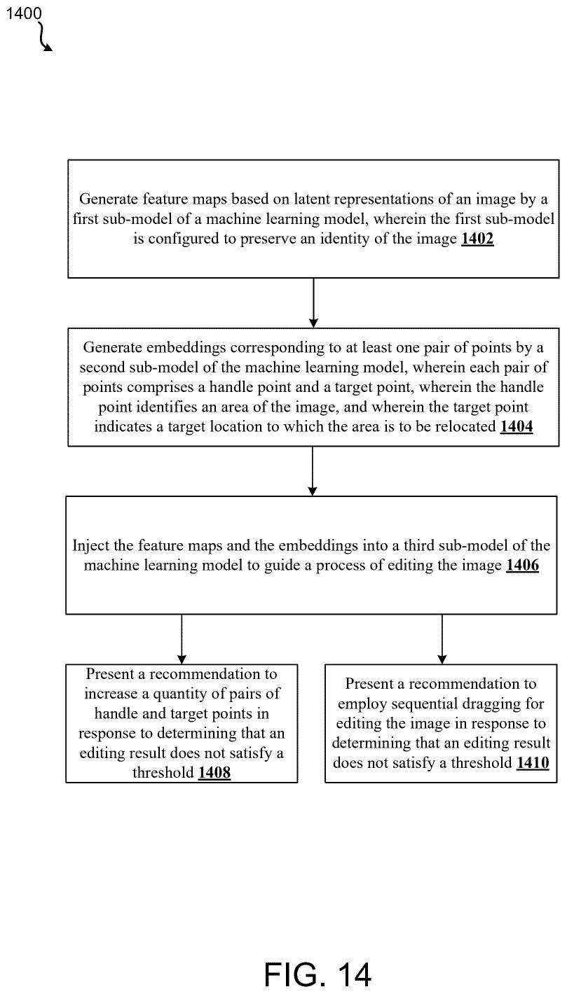

FIG. 14 illustrates an example process 1400 for implementing drag-based image editing. Although depicted as a sequence of operations in FIG. 14, those of ordinary skill in the art will appreciate that various embodiments may add, remove, reorder, or modify the depicted operations.

At 1402, feature maps can be generated. The feature maps can be generated based on latent representations of an image (e.g., image 101). The feature maps can be generated by a first sub-model (e.g., first sub-model 104) of a machine learning model (e.g., machine learning model 102). The first sub-model can be configured to preserve an identity of the image. The identity of the image can include information of identifying objects in the image, such as information indicating the appearance of the objects in the image.

At 1404, embeddings can be generated. The embeddings can correspond to at least one pair of points (e.g., pair of points 105). The embeddings can be generated by a second sub-model (e.g., second sub-model 106) of the machine learning model (e.g., machine learning model 102). Each pair of points (e.g., pair of points 105) comprises a handle point and a target point. The handle point identifies an area (e.g., region, one or more pixels) of the image. The corresponding target point indicates a target location to which the area is to be relocated or dragged.

At 1406, the feature maps and the embeddings can be injected into a third sub-model (e.g., third sub-model 108) of the machine learning model. The feature maps and the embeddings can be injected into the third sub-model of the machine learning model to guide a process of generating a target image by the third sub-model. For example, the feature maps and the embeddings can be used to guide the third sub-model during the process of generating the target image based on noised latent representations of the image, masked latent representations of the image, and a binary mask. The target image can depict the area of the image relocated at the target location.

Some images generated by the third sub-model during the process of generating the target image can be of a quality that is unsatisfactory to a user. Such failure cases can be mitigated by engineering the input drag instruction. The user-input drag instruction can be engineered using a point augmentation strategy and/or a sequential dragging strategy.

At 1408, a recommendation can be presented. The recommendation can include a recommendation to increase a quantity of pairs of handle and target points. The recommendation can be presented in response to determining that an editing result does not satisfy a threshold. It can be determined that an editing result does not satisfy a threshold based on user input indicating that the user is not satisfied with the editing result.

At 1410, recommendation can be presented. The recommendation can include a recommendation to employ sequential dragging for editing the image in response to determining that an editing result does not satisfy a threshold. It can be determined that an editing result does not satisfy a threshold based on user input indicating that the user is not satisfied with the editing result.

The performance of the machine learning model 102 was evaluated. To train the machine learning model 102 for evaluation, 220 k training samples were sampled from a video dataset. The learning rate was set to 5e-5 with a batch size of 256. The third sub-model 108 and the fourth sub-model 206 were both frozen, and the first sub-model 104 and the second sub-model 106 were trained.

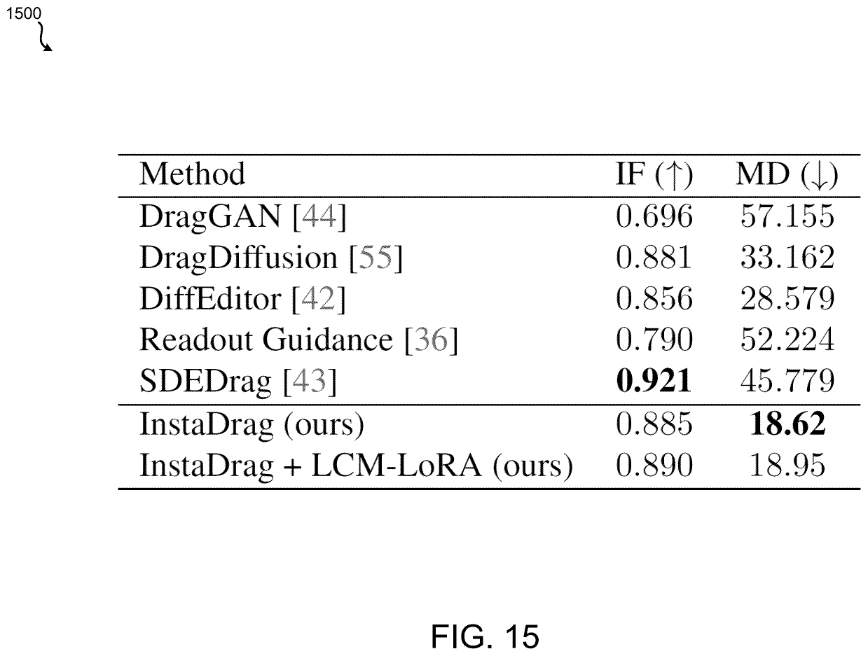

The performance of the trained machine learning model was evaluated on a dataset comprising 205 samples with pre-defined drag points and masks. The Image Fidelity (IF) and Mean Distance (MD) metrics were used for performance evaluation. IF is calculated as 1-LPIPS and represents the ability of a process to render an image accurately, without any visible distortion or information loss. MD assesses the accuracy with which handle points are moved to their designated targets. An ideal drag-based editing method would achieve a low MD, indicating effective drag editing, coupled with a high IF, signifying robust appearance preservation. The table 1500 of FIG. 15 demonstrates the superiority of the techniques described herein (i.e., INSTADRAG in the table 1500) in term of point following, as evidenced by its lowest MD. The table 1500 also shows that the techniques described herein outperforms most of the other techniques in term of IF.

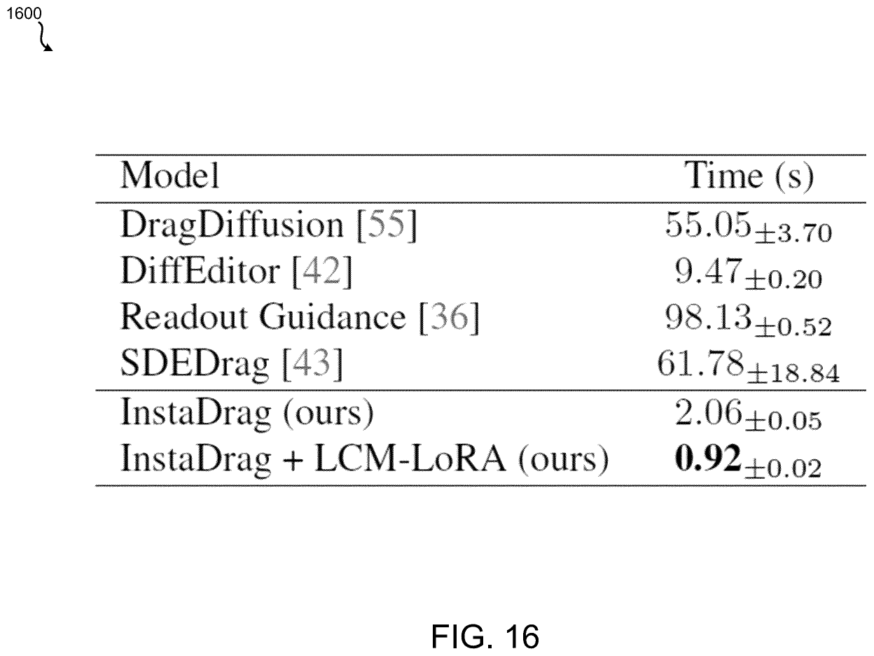

Due to the elimination of test-time latent optimization or gradient-based guidance, the techniques described herein are extremely fast. The time efficiency of techniques described herein was compared against the time efficiency of state-of-the-art methods. The results are shown in the table 1600 of FIG. 16. As shown in the table 1600, the technique described herein runs at a constant speed regardless of the dragging distance. Secondly, even without LCMLoRA, the technique described herein is already an order of magnitude faster than most baselines, making it suitable for practical applications. Lastly, when combined with recent diffusion acceleration methods such as LCM-LoRA, the technique described herein can be further accelerated, requiring only <1s for each dragging operation.

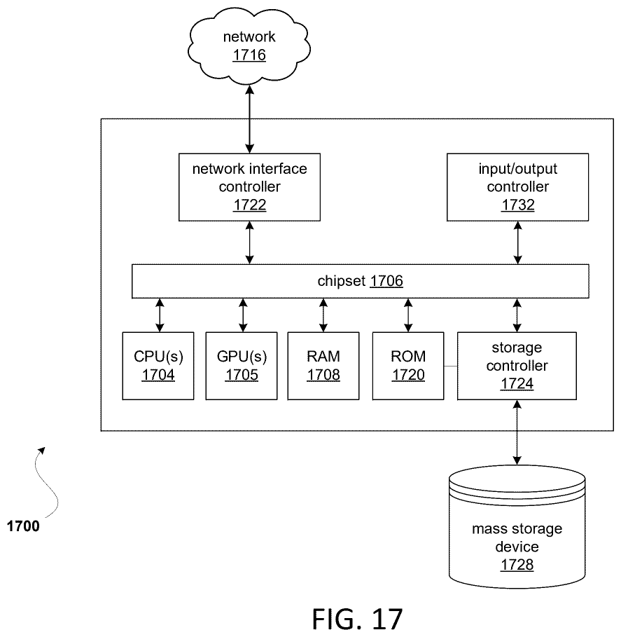

FIG. 17 illustrates a computing device that may be used in various aspects, such as the model(s), components, and/or devices depicted in FIGS. 1 and 2. With regard to FIGS. 1 and 2, any or all of the components may each be implemented by one or more instance of a computing device 1700 of FIG. 17. The computer architecture shown in FIG. 17 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1700 may include a baseboard, or “motherboard,” which is a printed circuit board to which a multitude of components or devices may be connected by way of a system bus or other electrical communication paths. One or more central processing units (CPUs) 1704 may operate in conjunction with a chipset 1706. The CPU(s) 1704 may be standard programmable processors that perform arithmetic and logical operations necessary for the operation of the computing device 1700.

The CPU(s) 1704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1704 may be augmented with or replaced by other processing units, such as GPU(s) 1705. The GPU(s) 1705 may comprise processing units specialized for but not necessarily limited to highly parallel computations, such as graphics and other visualization-related processing.

A chipset 1706 may provide an interface between the CPU(s) 1704 and the remainder of the components and devices on the baseboard. The chipset 1706 may provide an interface to a random-access memory (RAM) 1708 used as the main memory in the computing device 1700. The chipset 1706 may further provide an interface to a computer-readable storage medium, such as a read-only memory (ROM) 1720 or non-volatile RAM (NVRAM) (not shown), for storing basic routines that may help to start up the computing device 1700 and to transfer information between the various components and devices. ROM 1720 or NVRAM may also store other software components necessary for the operation of the computing device 1700 in accordance with the aspects described herein.

The computing device 1700 may operate in a networked environment using logical connections to remote computing nodes and computer systems through local area network (LAN). The chipset 1706 may include functionality for providing network connectivity through a network interface controller (NIC) 1722, such as a gigabit Ethernet adapter. A NIC 1722 may be capable of connecting the computing device 1700 to other computing nodes over a network 1716. It should be appreciated that multiple NICs 1722 may be present in the computing device 1700, connecting the computing device to other types of networks and remote computer systems.

The computing device 1700 may be connected to a mass storage device 1728 that provides non-volatile storage for the computer. The mass storage device 1728 may store system programs, application programs, other program modules, and data, which have been described in greater detail herein. The mass storage device 1728 may be connected to the computing device 1700 through a storage controller 1724 connected to the chipset 1706. The mass storage device 1728 may consist of one or more physical storage units. The mass storage device 1728 may comprise a management component 1710. A storage controller 1724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1700 may store data on the mass storage device 1728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1728 is characterized as primary or secondary storage and the like.

For example, the computing device 1700 may store information to the mass storage device 1728 by issuing instructions through a storage controller 1724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1700 may further read information from the mass storage device 1728 by detecting the physical states or characteristics of one or more particular locations within the physical storage units.

In addition to the mass storage device 1728 described above, the computing device 1700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1728 depicted in FIG. 17, may store an operating system utilized to control the operation of the computing device 1700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1728 may store other system or application programs and data utilized by the computing device 1700.

The mass storage device 1728 or other computer-readable storage media may also be encoded with computer-executable instructions, which, when loaded into the computing device 1700, transforms the computing device from a general-purpose computing system into a special-purpose computer capable of implementing the aspects described herein. These computer-executable instructions transform the computing device 1700 by specifying how the CPU(s) 1704 transition between states, as described above. The computing device 1700 may have access to computer-readable storage media storing computer-executable instructions, which, when executed by the computing device 1700, may perform the methods described herein.

A computing device, such as the computing device 1700 depicted in FIG. 17, may also include an input/output controller 1732 for receiving and processing input from a number of input devices, such as a keyboard, a mouse, a touchpad, a touch screen, an electronic stylus, or other type of input device. Similarly, an input/output controller 1732 may provide output to a display, such as a computer monitor, a flat-panel display, a digital projector, a printer, a plotter, or other type of output device. It will be appreciated that the computing device 1700 may not include all of the components shown in FIG. 17, may include other components that are not explicitly shown in FIG. 17, or may utilize an architecture completely different than that shown in FIG. 17.

As described herein, a computing device may be a physical computing device, such as the computing device 1700 of FIG. 17. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing drag-based image editing, comprising:
generating feature maps based on latent representations of an image by a first sub-model of a machine learning model, wherein the first sub-model is configured to preserve an identity of the image;
generating embeddings corresponding to at least one pair of points by a second sub-model of the machine learning model, wherein each pair of points comprises a handle point and a target point, wherein the handle point identifies an area of the image, and wherein the target point indicates a target location to which the area is to be relocated; and
injecting the feature maps and the embeddings into a third sub-model of the machine learning model to guide a process of generating a target image by the third sub-model, wherein the target image depicts the area of the image relocated at the target location.

2. The method of claim 1, further comprising:
inputting clean latent representations of the image into the first sub-model; and
extracting the feature maps by the first sub-model once during the process of generating the target image.

3. The method of claim 1, further comprising:
converting the handle point into a handle map and converting the target point into a target map; and
encoding the handle map and the target map into the embeddings by the second sub-model.

4. The method of claim 1, further comprising:
generating the target image by the third sub-model based on noised latent representations of the image, masked latent representations of the image and a binary mask that indicate a region of the image to remain unedited during the process of generating the target image.

5. The method of claim 1, further comprising:
extracting image features from the image using a fourth sub-model of the machine learning model; and
injecting the image features into the third sub-model to guide the process of generating the target image by the third sub-model.

6. The method of claim 1, further comprising:
employing a time-dependent classifier-free guidance (CFG) mechanism to strengthen effects of the embeddings corresponding to the at least one pair of points during the process of generating the target image.

7. The method of claim 1, further comprising:
generating pairs of training data using videos, wherein each pair of training data comprises a reference frame and a target frame, wherein each reference frame comprises at least one reference handle point for identifying an area of the reference frame, and wherein each target frame comprises at least one ground-truth target point indicating a location where the area is relocated; and
training the machine learning model on the pairs of training data.

8. The method of claim 7, wherein training the machine learning model on the pairs of training data comprises training the first sub-model and the second sub-model on the pairs of training data while keeping the third-sub model frozen.

9. The method of claim 1, further comprising:
presenting a recommendation to increase a quantity of pairs of handle and target points in response to determining that an editing result does not satisfy a threshold.

10. The method of claim 1, further comprising:
presenting a recommendation to employ sequential dragging for editing the image in response to determining that an editing result does not satisfy a threshold.

11. The method of claim 1, wherein the identity of the image comprises information of identifying objects in the image.

12. A system of implementing drag-based image editing, comprising:
at least one processor; and
at least one memory communicatively coupled to the at least one processor and comprising computer-readable instructions that upon execution by the at least one processor cause the at least one processor to perform operations comprising:
generating feature maps based on latent representations of an image by a first sub-model of a machine learning model, wherein the first sub-model is configured to preserve an identity of the image;
generating embeddings corresponding to at least one pair of points by a second sub-model of the machine learning model, wherein each pair of points comprises a handle point and a target point, wherein the handle point identifies an area of the image, and wherein the target point indicates a target location to which the area is to be relocated; and
injecting the feature maps and the embeddings into a third sub-model of the machine learning model to guide a process of generating a target image by the third sub-model, wherein the target image depicts the area of the image relocated at the target location.

13. The system of claim 12, the operations further comprising:
inputting clean latent representations of the image into the first sub-model; and
extracting the feature maps by the first sub-model once during the process of generating the target image.

14. The system of claim 12, the operations further comprising:
converting the handle point into a handle map and converting the target point into a target map; and
encoding the handle map and the target map into the embeddings by the second sub-model.

15. The system of claim 12, the operations further comprising:
generating the target image by the third sub-model based on noised latent representations of the image, masked latent representations of the image and a binary mask that indicate a region of the image to remain unedited during the process of generating the target image.

16. The system of claim 12, the operations further comprising:
extracting image features from the image using a fourth sub-model of the machine learning model; and
injecting the image features into the third sub-model to guide the process of generating the target image by the third sub-model.

17. A non-transitory computer-readable storage medium, storing computer-readable instructions that upon execution by a processor cause the processor to implement operations comprising:
generating feature maps based on latent representations of an image by a first sub-model of a machine learning model, wherein the first sub-model is configured to preserve an identity of the image;
generating embeddings corresponding to at least one pair of points by a second sub-model of the machine learning model, wherein each pair of points comprises a handle point and a target point, wherein the handle point identifies an area of the image, and wherein the target point indicates a target location to which the area is to be relocated; and
injecting the feature maps and the embeddings into a third sub-model of the machine learning model to guide a process of generating a target image by the third sub-model, wherein the target image depicts the area of the image relocated at the target location.

18. The non-transitory computer-readable storage medium of claim 17, the operations further comprising:
inputting clean latent representations of the image into the first sub-model; and
extracting the feature maps by the first sub-model once during the process of generating the target image.

19. The non-transitory computer-readable storage medium of claim 17, the operations further comprising:
converting the handle point into a handle map and converting the target point into a target map; and
encoding the handle map and the target map into the embeddings by the second sub-model.

20. The non-transitory computer-readable storage medium of claim 17, the operations further comprising:
generating the target image by the third sub-model based on noised latent representations of the image, masked latent representations of the image and a binary mask that indicate a region of the image to remain unedited during the process of generating the target image.
